(19) United States
(12) Patent Application Publication
(10) Pub. No.: US 2010/0124692 A1
(43) Pub. Date: May 20, 2010

(54) Battery pack and hand-held power tool

(75) Inventor: Ulrich Schiestl, Feldkirch (AT)

Correspondence Address: Davidson, Davidson & Kappel, LLC, 485 7th Avenue, 14th Floor, New York, NY, 10018, US

(73) Assignee: Hilti Aktiengesellschaft, Schaan (LI)

(21) Appl. No.: 12/590,905

(22) Filed: Nov. 16, 2009

(30) Foreign Application Priority Data
Nov. 19, 2008 (DE) DE102008043851.0

(51) Int. Cl. H01M 6/46

(52) U.S. Cl. 429/90; 429/153

(57) ABSTRACT

The present invention relates to a battery pack (10) having a housing (11) in which battery cells (12) are arranged and having electric contact elements (18) that are arranged on the housing (11). The battery pack also has a gas reservoir (15) and an output port (19) for gas that is connected to the gas reservoir (15) via a pressure line (16). Moreover, the invention relates to a hand-held power tool (30) having at least one electric consumer, having a cradle (31) for a battery pack (10), said cradle (31) comprising electric counter-contact elements (38) for the contact elements (18) of the battery pack (10), and said hand-held power tool having at least one device (35) that uses a gas that is under pressure. A connector (39) for an output port (19) of a gas reservoir (15) of the battery pack (10) is arranged on a cradle (31) of the hand-held power tool (30) for the battery pack (10), whereby said connector (39) is pneumatically connected to the device (35). In an associated hand-held power tool, a connector (39) for the output port (19) of the gas reservoir (15) of the battery pack (10) is arranged on a cradle (31) for the battery pack (10), whereby said connector (39) is pneumatically connected to the device (35).

This claims the benefit of German Patent Application No. 10 2008 043 851.0, filed Nov. 19, 2008 and hereby incorporated by reference herein.

### BACKGROUND

The present invention relates to a battery pack having a housing in which battery cells are arranged and having electric contact elements that are arranged on the housing. Such battery packs are used, among other things, in electrically operated hand-held power tools such as, for example, in electrically operated fastener driving devices. The invention also relates to a hand-held power tool of the type cited in the generic part of the subordinate claim. Such hand-held power tools draw the requisite operating power—at least at times—from a battery pack.

A battery pack of the generic type is known, for example, from German patent application DE 102 12 750 A1 that has several cells arranged in a housing. On one side of the housing, there are contact elements via which an electric connection can be established between the battery pack and the electric drive of a hand-held power tool. Latching elements arranged on the housing serve to attach the battery pack to the housing of a hand-held power tool.

German patent application DE 196 29 762 A1 discloses a hand-held power tool configured as an electrically operated fastener driving device that has an intermediate reservoir for kinetic energy in the form of a pneumatic spring. The energy stored in the pneumatic spring is used to rapidly accelerate a driving tappet of the fastener driving device. The pneumatic spring is charged by means of an electric drive that biases the pneumatic spring before a fastener driving procedure. A gas reservoir is arranged in the fastener driving device so that it is possible to repeatedly compensate for a loss of gas from the pneumatic spring caused by an unavoidable leakage that occurs. In order for the gas reservoir to contain sufficient gas for the entire service life of the fastener driving device, on the one hand, the gas cartridge has to be relatively large and, on the other hand, the gas in the reservoir has to be either liquefied or has to be in a supercritical state. Furthermore, there is also a cradle for a battery pack on the fastener driving device and this battery pack supplies the electric power for the electric drive.

### SUMMARY OF THE INVENTION

A drawback of this fastener driving device is, first of all, that it is very large and secondly, that it is very laborious and expensive to replace the gas reservoir if it becomes empty before the end of the service life of the fastener driving device.

It is an objective of the present invention to develop a battery pack of the above-mentioned type that is optimally adapted for use with hand-held power tools whose operation requires electric power as well as gas that is under pressure. Another objective lies in putting forward a hand-held power tool that is adapted for operation with a battery pack according to the invention.

The present invention provides a battery pack having a housing in which battery cells are arranged and having electric contact elements that are arranged on the housing. Further, the battery pack has a gas reservoir and an output port for gas that is connected to the gas reservoir via a pressure line.

Thanks to this measure, the battery pack can supply not only electric power but also gas that is under pressure (such as, for example, compressed air). The gas that is under pressure and that is supplied by the battery pack can be used in a hand-held power tool such as an electrically operated fastener driving device with a pneumatic spring, for example, in order to compensate for a gas loss from the pneumatic spring due to leakage. The gas reservoir in the battery pack can be configured to be relatively small, since it can likewise be recharged during each battery charging procedure. Thus, a battery charger can be configured in such a way that, in addition to an electric contact point for charging the cells of the battery pack, it also has a connection point for the output port, in order to re-fill the gas reservoir in parallel to the electric charging procedure.

Advantageously, the gas reservoir is arranged inside the housing in such a way that the appearance of the battery pack does not differ from that of a conventional battery pack, and so that the gas reservoir is protected against penetration by dirt or moisture or against impact.

It is also advantageous for the contact elements and the output port to be arranged on a shared connection port so that, when the battery pack is attached to a device such as a hand-held power tool or charger, the contact elements and the output port are connected simultaneously to counter-contacts and to connection means located on the device.

It is also practical for an electronic unit to be provided that has a temperature sensor, so that, first of all, the temperature of the battery cells can be monitored and secondly, so that the gas reservoir can also be monitored indirectly (e.g. in case of severe cooling). Moreover, the electronic unit could also be connected to a pressure sensor to monitor the pressure in the pressure reservoir or to a pressure relief valve that functions as a safety valve.

When it comes to a hand-held power tool, the envisaged objective is achieved in that a connection means for an output port of a gas reservoir of the battery pack is arranged on the cradle for the battery pack, whereby said connection means is pneumatically connected to the device (such as, for example, a pneumatic spring). In this manner, an electric as well as a pneumatic connection can be established between the hand-held power tool and the battery pack.

Advantageously, the electric counter-contact elements and the connection means are arranged on a shared counter-connection port so that, when the battery pack is attached to the hand-held power tool, the contact elements and the output port are simultaneously connected to counter-contacts and connection means located on the device.

### BRIEF DESCRIPTION OF THE DRAWINGS

The invention is explained in the drawings below on the basis of an embodiment. The following is shown:

FIG. 1 a longitudinal section of a battery pack according to the invention,

FIG. 2 a longitudinal section of a fastener driving device with a battery pack according to the invention situated in a battery cradle.

### DETAILED DESCRIPTION

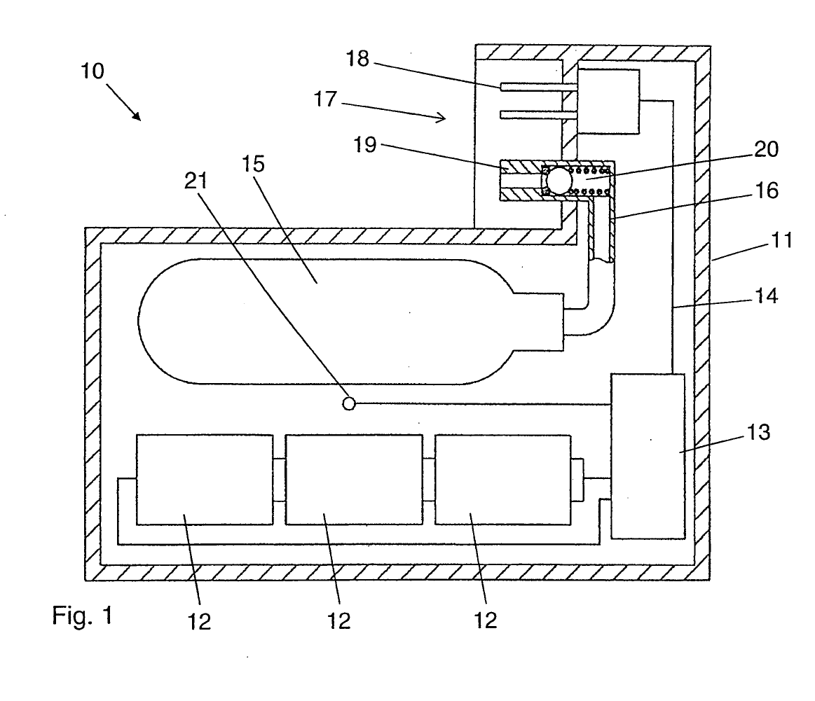

FIG. 1 shows a battery pack 10 according to the invention comprising a housing 11 and a plurality of battery cells 12 that are electrically connected to each other and that are arranged in the housing 11. In this context, the battery pack can be configured, for instance, as a lithium-titanate, NiCd, NiMH, Li-ion, Li-polymer or Li—Fe battery.

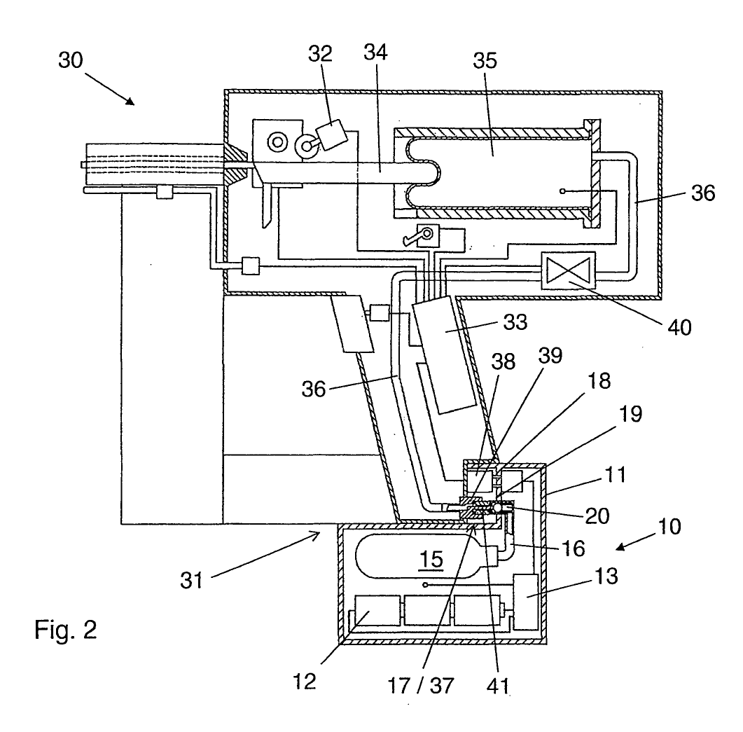

The battery pack 10 also has an electronic unit 13 configured as an electronic control unit that is electrically connected to the battery cells 12 and monitors them, said electric unit being connected via an electric line 14 to electric contact elements 18 that are arranged on the housing 11. The contact elements 18 are arranged at a connection port 17 that can be connected to a counter-connection port 37 of a hand-held power tool 30 (see FIG. 2), of a charger or the like. The electronic unit 13 is also connected to a temperature sensor 21 such as, for instance, an NTC (negative temperature coefficient thermistor), as a result of which the temperature of the battery cells 12 can be monitored.

The housing 11 of the battery pack 10 also contains a gas reservoir 15 configured as a pressure vessel for a gaseous medium that is under pressure such as, for example, compressed air. Here, the gas reservoir 15 is connected via a pressure line 16 to an output port 19 that is arranged adjacent to the contact elements 18 at the connection port 17 on the outside of the housing 11. Moreover, a valve 20 that, without being activated, prevents gas or gaseous medium from flowing out of the gas reservoir 15 is arranged in the pressure line 16 near the output port 19.

In FIG. 2, the battery pack 10 is attached to a hand-held power tool 30 that is configured as an electric fastener driving device. The hand-held power tool 30 has electric consumers such as, for example, an electric drive motor 32 and an electronic control unit 33. Moreover, the hand-held power tool also has a device 35 configured as a pneumatic spring. For this purpose, the drive motor 32 is configured so as to move a driving tappet 34 from its initial position shown in FIG. 2 into a position in which it is biased against the pneumatic pressure spring or against the device 35.

The pneumatic spring/device 35 is pneumatically connected to a connector or connection means 39 for the output port 19 of the battery pack 10 via a line 36 in which a valve means 40 is installed that can be regulated by the electronic control unit 33. Here, the connection means 39 is arranged together with counter-contact elements 38 on a counter-connection port 37 for the connection port 17 of the battery pack 10 in the area of a cradle 31 of the hand-held power tool 30 for the battery pack 10. When the battery pack 10 is attached to the cradle 31 of the hand-held power tool 30, the connection port 17 is coupled to the counter-connection port 37 and an electric connection is established between the contact elements 18 and the counter-contact elements 38, and, at the same time, a pneumatic connection is established between the output port 19 and the connection means 39. A positioning element 41 that is configured as a mandrel and that is situated on the connection means 39 which—after the output port 19 and the connection means 39 have been coupled—extends into the output port, causes the valve 20 to open so that now the gas flow is only dependent on the controlled valve means 40.

What is claimed is:

1. A battery pack comprising:
a housing including battery cells and having electric contact elements arranged on the housing;
a gas reservoir;
an output port for gas in the gas reservoir; and
a pressure line connecting the gas reservoir to the output port.

2. The battery pack as recited in claim 1 wherein the gas reservoir is arranged inside the housing.

3. The battery pack as recited in claim 1 wherein the contact elements and the output port are arranged on a shared connection port.

4. The battery pack as recited in claim 1 further comprising an electronic unit having a temperature sensor.

5. A hand-held power tool comprising:
at least one electric consumer having a cradle for a battery pack, the cradle including electric counter-contact elements for contact elements of the battery pack;
at least one device using a gas under pressure; and
a connector for an output port of a gas reservoir of the battery pack, the connector being arranged on the cradle and pneumatically connected to the at least one device.

6. The hand-held power tool as recited in claim 5 wherein the electric counter-contact elements and the connector are arranged on a shared counter-connection port.
